(19) United States
(12) Patent Application Publication
(10) Pub. No.: US 2026/0371061 A1
(43) Pub. Date: Nov. 19, 2026

(54) SYSTEMS AND METHODS FOR CONSUMER NETWORK FUNCTION SUBSCRIPTION TIMER AT BINDING SUPPORT FUNCTION OF WIRELESS NETWORK

(71) Applicant: Verizon Patent and Licensing Inc., Basking Ridge, NJ (US)

(72) Inventors: Lixia Yan, Basking Ridge, NJ (US); Violeta Cakulev, Milburn, NJ (US); Ali Imdad Malik, East Brunswick, NJ (US); Hossein M. Ahmadi, Parsippany, NJ (US)

(73) Assignee: Verizon Patent and Licensing Inc., Basking Ridge, NJ (US)

(21) Appl. No.: 19/208,362

(22) Filed: May 14, 2025

(51) Int. Cl. H04W 8/18; H04W 8/20; H04W 76/20

(52) U.S. Cl. CPC H04W 8/183; H04W 8/20; H04W 76/20

(57) ABSTRACT

A device described herein, such as a Binding Support Function (“BSF”) of a wireless network, may maintain binding information that associates respective Policy Control Function (“PCFs”) of the wireless network with respective User Equipment (“UEs”) that are connected to the wireless network; receive a subscription request, from a particular Network Function (“NF”) of the wireless network, for binding information updates associated with a particular UE; initiate, based on receiving the subscription request, a subscription timer that is associated with the particular NF; receive, prior to expiration of the subscription timer, one or more binding information updates associated with the particular UE; notify, based on the subscription request, the particular NF of the one or more binding information updates received prior to expiration of the subscription timer; determine that the subscription timer has expired; and forgo notifying the particular NF of binding information updates received after expiration of the subscription timer.

### BACKGROUND

Wireless networks provide wireless connectivity to User Equipment (“UEs”), such as mobile telephones, tablets, Internet of Things (“IoT”) devices, Machine-to-Machine (“M2M”) devices, or the like. Wireless networks may include Network Functions (“NFs”), such as Policy Control Functions (“PCFs”), that enforce policies, such as Quality of Service (“QoS”) policies, access policies, and/or other policies in order to maintain network security, performance, stability, and/or other factors. NFs of the wireless network may be implemented in a distributed or containerized manner, such that multiple instances of the same type of NF may be present in the wireless network. For example, multiple different PCF instances may be implemented in the wireless network.

The wireless network may include an NF, such as a Binding Support Function (“BSF”), which maintains information associating particular PCF instances with particular UEs or communication sessions (e.g., protocol data unit (“PDU”) sessions). NFs of the wireless network, such as “consumer” NFs that may seek to identify which PCF instance is associated with a particular UE or communication session may issue a query to a BSF in order to attempt to identify which (if any) of the particular PCF instances maintain information associating the particular UE or communication session with a particular PCF instance.

### BRIEF DESCRIPTION OF THE DRAWINGS

FIG. 1 illustrates an example overview of one or more embodiments described herein;

FIG. 2 illustrates an example of implementing a subscription timer at a BSF based on a duration specified by a consumer NF, in accordance with some embodiments;

FIG. 3 illustrates an example of implementing a subscription timer at a BSF based on modifying a duration specified by a consumer NF, in accordance with some embodiments;

FIG. 4 illustrates an example of renewing a subscription timer at a BSF, in accordance with some embodiments;

FIG. 5 illustrates an example of a BSF confirming that a subscription, by a consumer NF for binding information associated with a particular UE, should be removed, in accordance with some embodiments;

FIG. 6 illustrates an example process for implementing a subscription timer at a BSF of a wireless network, in accordance with some embodiments;

FIGS. 7 and 8 illustrate example environments in which one or more embodiments, described herein, may be implemented;

FIG. 9 illustrates an example arrangement of a radio access network (“RAN”), in accordance with some embodiments; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

A BSF of a wireless network may maintain and provide (e.g., to other NFs of the wireless network) PCF binding information, which includes information associating particular UEs to particular PCFs (e.g., where a respective PCF or set of PCFs may may maintain policy information for a given UE or set of UEs). The BSF may maintain up-to-date binding information associated with a given UE. In some scenarios, the binding information for a given UE may change. For example, a particular PCF may begin maintaining policy information for a given UE when a new communication session is established between the UE and the wireless network. As another example, the wireless network may change the PCF or PCF instance maintaining policy information for a given UE. When the binding information for a given UE changes (e.g., in the scenarios mentioned above or in other scenarios), the BSF may update the binding information to reflect the change in the binding information.

The BSF may further automatically notify other NFs of the network (e.g., “consumer” NFs) of the change. For example, consumer NFs of the wireless network may “subscribe” to binding information changes associated with a given UE. Subscribing to binding information changes for a given UE may include indicating, to the BSF, that the consumer NF should be notified (e.g., automatically notified, or that a “push” notification should be sent) when the binding information for the UE changes (e.g., is updated). Based on receiving binding information changes or updates for a given UE, the BSF may automatically notify consumer NFs, which have subscribed to binding changes for the UE, of the binding information changes. In one example, one or more PCFs may be deployed in a split functionality implementation, such as an implementation in which a first type of PCF (e.g., a UE PCF) maintains or propagates UE policies; a second type of PCF (e.g., as an Access and Mobility (“AM”) PCF) that maintains or propagates AM policies, and/or one or a third type of PCF (e.g., a Session Management (“SM”) PCF) maintains or propagates SM policies.

The AM PCF may implement UE access policies (e.g., which may be used to modify RAN configuration information) based on identifying and communicating with SM PCFs that manage the establishment of communication sessions between the UE and the wireless network. For example, an SM PCF may indicate, to the AM PCF, that a communication session for the UE is associated with a particular service, Data Network Name (“DNN”), network slice, set of QoS parameters, or the like. The AM PCF may accordingly implement or propagate AM policies to a RAN, which may modify RAN configuration parameters (e.g., radio access technology (“RAT”)/Frequency Selection Priority (“RFSP”) parameters or other parameters) in accordance with the AM policies.

Scenarios may arise in which the BSF maintains “stale” subscriptions (e.g., that are no longer needed). For example, a given consumer NF, such as an AM PCF, may subscribe to binding information updates for a given UE (e.g., which may include the association of the UE with one or more SM PCFs) and may subsequently output an instruction to the BSF to remove the subscription, such as when the consumer NF no longer requires or uses the binding information for the UE. If the instruction is dropped or is otherwise not received by the BSF, the BSF may continue consuming resources (e.g., processing resources, network resources, etc.) to implement the subscription, even though the subscription has become stale or is otherwise no longer needed or used by the consumer NF. As another example, the consumer NF may be misconfigured, may undergo a hardware failure, or may otherwise not instruct the BSF to remove the subscription for the binding information associated with the UE, even in situations where such binding information is no longer needed. In situations where a BSF maintains numerous (e.g., thousands, tens of thousands, or more) subscriptions, implementing stale or otherwise unneeded subscriptions may unnecessarily introduce a relatively burden on the processing resources, storage resources, and/or network resources of the BSF and/or of the network in general.

Embodiments described herein provide techniques for removing stale subscriptions from the BSF, thus freeing up computing resources, network resources, or other hardware resources that would otherwise be used to implement such subscriptions. Further, as discussed below, the removal of binding information subscriptions may be performed in a manner that does not remove binding information subscriptions that are still in use by one or more respective consumer NFs. In one example embodiment, a BSF may implement a subscription timer for a respective subscription associated with a consumer NF, based on which the BSF may identify when the subscription has become stale (or potentially stale), and may take remedial measures such as proactively removing the subscription, thus freeing up BSF resources and increasing the overall efficiency of the BSF. In some embodiments, the BSF may confirm the removal of the subscription with the consumer NF, in order to ensure that subscriptions that are still in use are not removed.

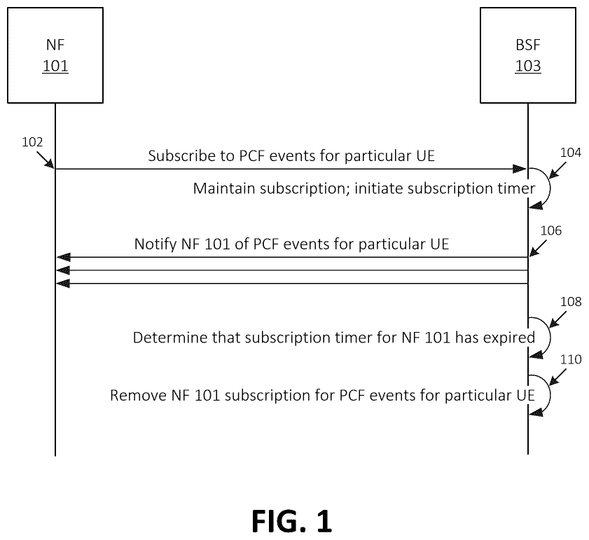

As shown in FIG. 1, NF 101 (e.g., a particular consumer NF) subscribes (at 102) to PCF events for a particular UE. For example, NF 101 may output at (102) a subscription message to BSF 103. The subscription message may include, for example, an Nbsf_Management_Subscribe message and/or some other suitable message that indicates that NF 101 is requesting ongoing updates to PCF events (e.g., binding information) associated with the particular UE. A “PCF event” may refer to, for example, a new PCF being assigned to or otherwise associated with the particular UE, a PCF being removed from the particular UE, a PCF assignment for the particular UE being changed from a first instance of the PCF to a second instance of the PCF, or other types of events. In one example, a PCF event may refer to the creation, modification, or deletion of policy context information, associated with a particular UE, by a particular PCF.

In the examples described herein, the subscription specifies a particular UE, which may include one or more UE identifiers (e.g., a Mobile Directory Number (“MDN”), an International Mobile Subscriber Identity (“IMSI”) value, an International Mobile Station Equipment Identity (“IMEI”) value, a Subscription Permanent Identifier (“SUPI”), a Globally Unique Temporary Identifier (“GUTI”), an Internet Protocol (“IP”) address, and/or other one or more other suitable identifiers based on which a UE may be uniquely identified). In some embodiments, the subscription may specify additional conditions or parameters, such as binding information associated with a particular UE as well as a DNN, a network slice, and/or other suitable parameters.

BSF 103 may accordingly maintain (at 104) the subscription to PCF events associated with the particular UE. BSF 103 may also initiate (at 104) a subscription timer that is associated with the subscription. In this manner, BSF 103 may potentially maintain multiple subscription timers, such as a first subscription timer for a first subscription, a second subscription timer for a second subscription, a third subscription timer for a third subscription, and so on. As one example, the first subscription may indicate that binding updates for a first UE should be sent to a first NF 101; the second subscription may indicate that binding updates for a second UE should be sent to the first NF 101; and the third subscription may indicate that binding updates for a third UE should be sent to a second NF 101. Thus, the operations described herein with respect to one subscription may be performed (e.g., in parallel, asynchronously, contemporaneously, etc.) for multiple different subscriptions maintained by BSF 103.

In some embodiments, the subscription timer may be associated with a “default” or predetermined duration. In such embodiments, for example, the subscription request from NF 101 may not explicitly include a request to initiate the subscription timer. In other example implementations, as discussed below, the subscription request may include a request to initiate the subscription timer, and/or may include a requested duration of the subscription timer. While the subscription timer is running or has not expired (e.g., after the initiation of the subscription timer but before the associated duration has elapsed), BSF 103 may proceed to notify (at 106) NF 101 of PCF events for the particular UE, when such events occur (e.g., when BSF 103 receives or updates such binding information). In other words, BSF 103 may automatically provide, or “push,” updated binding information, for the particular UE specified in the subscription request (at 102), to NF 101.

In implementations where the subscription specifies additional parameters (e.g., in addition to a UE identifier), BSF 103 may notify (at 106) NF 101 of PCF events that satisfy the additional parameters, without notifying NF 101 of PCF events that do not satisfy the additional parameters. For example, assume that NF 101 specified (at 102) that NF 101 should be notified of PCF events for a particular UE, where the PCF event is further associated with a particular DNN or network slice. BSF 103 may accordingly notify NF 101 when a PCF event associated with the particular DNN or network slice occurs with respect to the particular UE (e.g., if a PCF that is associated with the particular DNN or network slice begins maintaining policy information associated with the particular UE, as one example). On the other hand, BSF 103 may forgo notifying NF 101 when a PCF event associated with a different DNN or network slice (e.g., a DNN or network slice that is not specified in the subscription request) occurs with respect to the particular UE.

At some point, BSF 103 may determine (at 108) that the subscription timer has expired. For example, sometime after initiating (at 104) the subscription timer, BSF 103 may determine (at 108) that the duration associated with the subscription timer has elapsed. In other words, BSF may determine that the subscription, by NF 101, for PCF events associated with the particular UE has become stale. Based on determining that the subscription timer has expired, BSF 103 may remove (at 110) the subscription, by NF 101, for PCF events (e.g., binding updates) pertaining to the particular UE. Removing the subscription may include, for example, ceasing checking for binding updates associated with the particular UE (e.g., in the event that BSF 103 no longer maintains any subscriptions for binding updates associated with the particular UE once the subscription is removed). Additionally, or alternatively, removing the subscription may include ceasing to output notifications, to NF 101, of PCF events associated with the particular UE (e.g., which may be applicable in situations where BSF 103 continues to receive indications of PCF events associated with the particular UE, but for which NF 101 no longer requires or uses such indications). As discussed above, removing the subscription may free up resources of BSF 103, thus enhancing the efficiency of BSF 103.

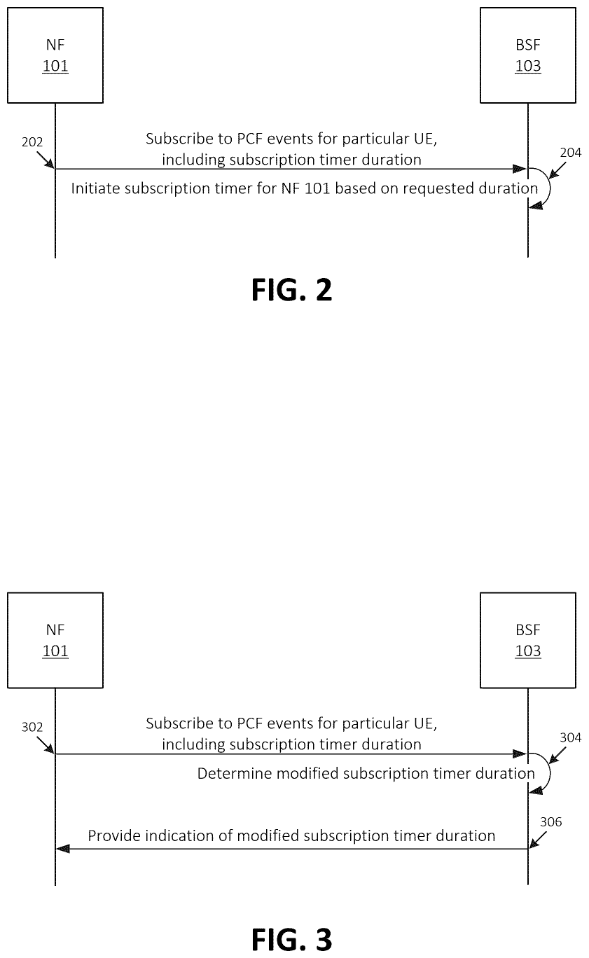

As noted above, and as shown in FIG. 2, NF 101 may specify a duration for a subscription timer when subscribing to binding updates (e.g., PCF events). For example, NF 101 may output (at 202) a subscription request to BSF 103, which specifies a particular subscription timer duration (e.g., 10 minutes, 30 minutes, one hour, or some other suitable duration). BSF 103 may accordingly initiate (at 204) the subscription timer, associated with NF 101, in accordance with the requested duration. Thus, when determining (e.g., at 108) that the subscription timer has expired, BSF 103 may determine that the duration specified in the request (at 202) has elapsed after initiation (at 204) of the timer. In some embodiments, the requested duration may be different from a “default” subscription timer duration implemented by BSF 103. In some embodiments, BSF 103 may forgo implementing a subscription timer unless a subscription timer is explicitly requested by NF 101 (e.g., at 202), and/or unless a subscription timer duration is specified by NF 101.

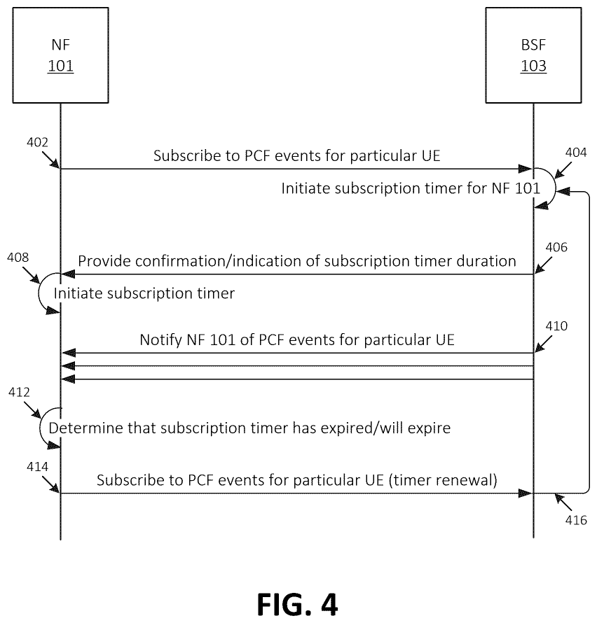

In some circumstances, BSF 103 may modify a requested subscription timer duration. For example, as shown in FIG. 3, and as similarly described above with respect to operation 202, NF 101 may subscribe (at 302) to PCF events associated with a particular UE, including specifying a subscription timer duration. BSF 103 may determine (at 304) a modified subscription timer duration that is different from the requested subscription timer duration. For example, BSF 103 may implement one or more policies based on which BSF 103 may determine that one or more requested subscription timer durations should be modified. In one example, the policies may include a maximum subscription timer duration, and BSF 103 may reduce the subscription timer duration down to the maximum subscription timer duration in circumstances where the requested subscription timer duration exceeds the maximum subscription timer duration. In other examples, other policies or techniques may be applied by BSF 103 in determining a modified subscription timer duration. In some embodiments, BSF 103 may provide (at 306) an indication of the modified subscription timer duration to NF 101. In this manner, NF 101 may be “aware” of how long the subscription is active (e.g., not removed).

In some scenarios, NF 101 may “renew” a PCF event subscription, such as by outputting a renewal request, a new subscription request, and/or some other type of indication to BSF 103. For example, NF 101 may renew the PCF event subscription prior to the expiration of the subscription timer, and being “aware” of the subscription timer duration may aid in NF 101 renewing the subscription before the expiration of the subscription timer, thus preventing the subscription from being removed prematurely.

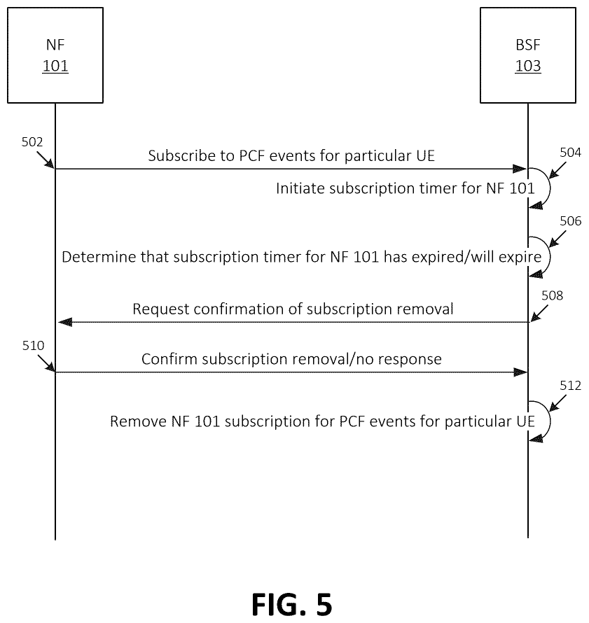

As shown in FIG. 4, for example, NF 101 may subscribe (at 402) to PCF events associated with a particular UE, and BSF 103 may initiate (at 404) a subscription timer for the subscription. As discussed above, the duration of the subscription timer may be a default duration, a duration specified by NF 101, and/or a duration determined by BSF 103. BSF 103 may provide (at 406) a confirmation and/or indication of the subscription timer duration. For example, BSF 103 may confirm that the subscription has been created, and/or may indicate the duration of the subscription timer. Accordingly, NF 101 may also initiate (at 408) a subscription timer (e.g., having the same duration as, and/or expiring at the same time as, the subscription timer initiated (at 404) by BSF 103).

As discussed above, while the subscription timer is running (e.g., prior to the subscription timer duration elapsing), BSF 103 may notify (at 410) NF 101 of PCF events for the particular UE indicated in the subscription request. At some point, NF 101 may determine (at 412) that the subscription timer has expired or will expire. For example, NF 101 may determine that the subscription timer duration has elapsed after NF 101 initiated (at 408) the subscription timer, and/or that the subscription timer duration will be elapsing within a certain period of time (e.g., within the next minute, within the next 30 seconds, or the like).

Based on determining that the subscription timer has expired (or will expire), NF 101 may initiate (at 414) a renewal of the subscription timer. For example, NF 101 may output a new subscription message (e.g., including some or all of the information included in the initial subscription message at 402), or may output some other type of indication indicating that the subscription is renewed or that the subscription timer should be reset or reinitialized. Based on the renewal, BSF 103 and/or NF 101 may repeat (at 416) some or all of the above operations. For example, BSF 103 and NF 101 may reinitiate their respective subscription timers (e.g., (at a subsequent iteration of operations 404 and 408, respectively), and BSF 103 may continue to notify (e.g., at a subsequent iteration of operation 410) NF 101 of PCF events for the particular UE.

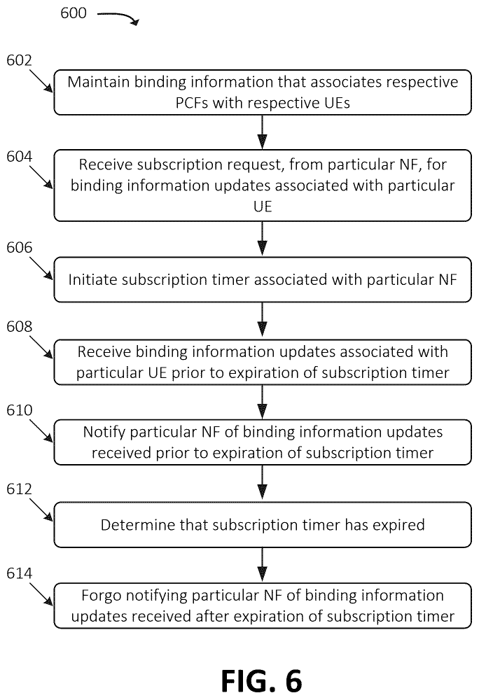

In some embodiments, BSF 103 may confirm that a subscription should be removed, prior to removing the subscription. For example, as shown in FIG. 5, NF 101 may subscribe (at 502) to PCF events associated with a particular UE, and BSF 103 may initiate (at 504) a subscription timer for the subscription. After some time, BSF 103 may determine (at 506) that the subscription timer has expired or will expire (e.g., that the corresponding subscription timer has elapsed or will elapse within a given upcoming timeframe). BSF 103 may accordingly request (at 508) confirmation of the removal of the subscription. For example, BSF 103 may indicate, to NF 101, that the subscription timer has expired or will expire, and/or may otherwise indicate that the subscription to PCF event information associated with the particular UE is subject to potential removal.

In some scenarios, NF 101 may respond to the request for confirmation of subscription removal with an indication that the subscription should not be removed (e.g., that the subscription should be renewed or that the subscription timer should be reinitiated, as similarly discussed above). On the other hand, in some scenarios, NF 101 may confirm (at 510) the removal of the subscription, such as by responding to BSF 103 with an indication that the subscription should be removed. In some scenarios, BSF 103 may not receive (at 510) a response from NF 101 (e.g., within a predetermined timeframe such as a “timeout” interval). Based on receiving a confirmation to the subscription removal, and/or based on not otherwise receiving a renewal request or other type of response, BSF 103 may remove (at 512) the subscription associated with NF 101.

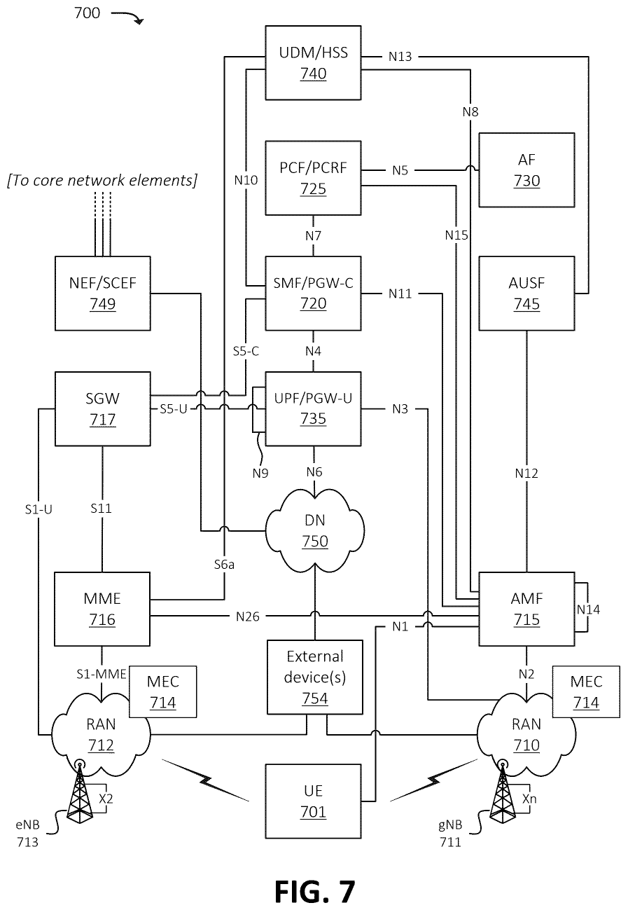

FIG. 6 illustrates an example process 600 for implementing a subscription timer at a BSF of a wireless network. In some embodiments, some or all of process 600 may be performed by BSF 103 or some other suitable NF (e.g., an NF that maintains and/or provides binding information, such as information that indicates an association between a particular UE with a particular PCF, a particular SM PCF, etc.).

As shown, process 600 may include maintaining (at 602) binding information associating respective PCFs of a wireless network with respective UEs that are connected to the wireless network. For example, BSF 103 may be communicatively coupled to one or more PCFs of the wireless network. In some implementations, as discussed above, the one or more PCFs may include split functionality PCFs, such as UE PCFs, AM PCFs, and/or SM PCFs. A respective PCF may notify BSF 103 of events such as the PCF creating a policy context for a particular UE, a PCF deleting or removing a policy context for a particular UE, or the like. For example, an SM PCF may receive a protocol data unit (“PDU”) session creation request from a particular UE, and may create a policy context for the requested PDU session associated with such UE (e.g., may obtain, maintain, propagate, etc. SM policies associated with the PDU session and/or the UE). As part of, or pursuant to, creating the policy context, the SM PCF may notify BSF 103 that the SM PCF has been bound to the particular UE (e.g., that the SM PCF maintains a policy context for the particular UE).

Process 600 may further include receiving (at 604) a subscription request, from a particular NF 101, for binding information updates associated with the particular UE. For example, as discussed above, BSF 103 may receive a subscription request that includes an identifier of the particular UE (e.g., a SUPI, a GUTI, and/or some other suitable identifier). As discussed above, the subscription request may include one or more other parameters, such as a DNN, a network slice, a subscription timer duration, and/or other suitable parameters. In one example, the subscription request may be received from an AM PCF that maintains an AM policy context for the particular UE (e.g., the AM PCF may have been bound to the UE as part of, or pursuant to, a registration procedure for the particular UE.

Process 600 may additionally include initiating (at 606) a subscription timer associated with the particular NF 101. For example, as discussed above, BSF 103 may initiate the subscription timer based on a default or predetermined duration, a duration requested by NF 101, and/or some other suitable duration.

Process 600 may also include receiving (at 608) binding information updates, associated with the particular UE, prior to the expiration of the subscription timer. As discussed above, the binding information updates may include the association (e.g., binding) of one or more PCFs (e.g., which may include an SM PCF, an AM PCF, or a UE PCF) with the particular UE. In one example, for example, the binding information update may include the association of the particular UE with a particular SM PCF, which may occur in a situation where a new PDU session has been established between the particular UE and the wireless network and in which the particular SM PCF maintains an SM policy context with respect to the particular UE.

Process 600 may further include notifying (at 610) the particular NF 101 of the binding information updates received prior to the expiration of the subscription timer. For example, BSF 103 may notify (e.g., output a “push” notification) to the particular NF 101 that updated binding information has been received with respect to the particular UE (e.g., information associating the particular UE with a particular PCF). The notification may include an identifier of the PCF, such as an IP address, an instance identifier, or other suitable identifier. As discussed above, the binding information may be used by the particular NF 101 for operations such as communicating with the indicated PCF in order to meet QoS parameters associated with policies implemented by the PCF. In one example in which NF 101 includes an AM PCF that implements AM policies with respect to the particular UE, the AM PCF may communicate with an SM PCF when the SM PCF begins to implement SM policies and/or otherwise begins to maintain an SM policy context with respect to the particular UE. As another example, the AM PCF may communicate with the SM PCF when the SM PCF updates or changes the SM policies implemented by the SM PCF with respect to the particular UE (e.g., when a PDU session is established between the particular UE and the wireless network, when an existing PDU session is modified, and/or in other situations). The AM PCF may, for example, receive network slice information, DNN information, service information, QoS information, or other suitable information from the SM PCF. As discussed above, the AM PCF may, based on the information received from the SM PCF, modify or implement a given set of AM policies, which may include causing one or more RAN elements to modify configuration information in order to meet QoS thresholds or other suitable thresholds associated with a network slice, DNN, etc. associated with a communication session between the UE and the wireless network.

Process 600 may additionally include determining (at 612) that the subscription timer has expired. For example, BSF 103 may determine that the duration of the timer has elapsed since the timer was initiated (at 606). In some embodiments, determining that the subscription timer has expired may include some or all of the concepts described above, such as determining that NF 101 has confirmed that NF 101 should no longer be subscribed to the binding information updates for the particular UE, and/or that NF 101 has not responded to a request to confirm whether NF 101 should be or should no longer be subscribed to such information. Additionally, as discussed above, the timer may be extended, renewed, reinitiated, etc. based on a renewal request or other suitable indication from NF 101.

Process 600 may also include forgoing notifying (at 614) the particular NF 101 of binding information updates received after the expiration of the subscription timer. For example, once the subscription timer has expired, NF 101 may no longer be considered as being subscribed to the binding information updates for the particular UE. As discussed above, in this scenario, BSF 103 may forgo providing, to NF 101, binding information updates for the particular UE. In this manner, BSF 103 may preserve resources that would otherwise be expended in checking for such updates and/or in notifying NF 101 of such updates.

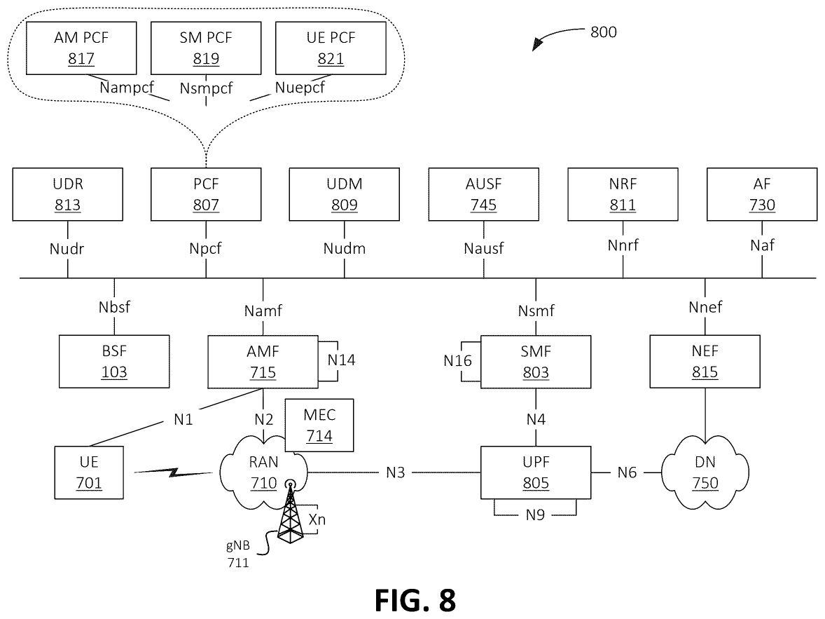

FIG. 7 illustrates an example environment 700, in which one or more embodiments may be implemented. In some embodiments, environment 700 may correspond to a Fifth Generation (“5G”) network, and/or may include elements of a 5G network. In some embodiments, environment 700 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 700 may represent or may include a 5G core (“5GC”). As shown, environment 700 may include UE 701, RAN 710 (which may include one or more Next Generation Node Bs (“gNBs”) 711), RAN 712 (which may include one or more evolved Node Bs (“eNBs”) 713), and various network functions such as Access and Mobility Management Function (“AMF”) 715, Mobility Management Entity (“MME”) 716, Serving Gateway (“SGW”) 717, Session Management Function (“SMF”)/Packet Data Network (“PDN”) Gateway (“PGW”)-Control plane function (“PGW-C”) 720, Policy Control Function (“PCF”)/Policy Charging and Rules Function (“PCRF”) 725, Application Function (“AF”) 730, User Plane Function (“UPF”)/PGW-User plane function (“PGW-U”) 735, Unified Data Management (“UDM”)/Home Subscriber Server (“HSS”) 740, Authentication Server Function (“AUSF”) 745, and Network Exposure Function (“NEF”)/Service Capability Exposure Function (“SCEF”) 749. Environment 700 may also include one or more networks, such as Data Network (“DN”) 750. Environment 700 may include one or more additional devices or systems communicatively coupled to one or more networks (e.g., DN 750), such as one or more external devices 754.

The example shown in FIG. 7 illustrates one instance of each network component or function (e.g., one instance of SMF/PGW-C 720, PCF/PCRF 725, UPF/PGW-U 735, UDM/HSS 740, and/or AUSF 745). In practice, environment 700 may include multiple instances of such components or functions. For example, in some embodiments, environment 700 may include multiple “slices” of a core network, where each slice includes a discrete and/or logical set of network functions (e.g., one slice may include a first instance of AMF 715, SMF/PGW-C 720, PCF/PCRF 725, and/or UPF/PGW-U 735, while another slice may include a second instance of AMF 715, SMF/PGW-C 720, PCF/PCRF 725, and/or UPF/PGW-U 735). The different slices may provide differentiated levels of service, such as service in accordance with different Quality of Service (“QoS”) parameters.

The quantity of devices and/or networks, illustrated in FIG. 7, is provided for explanatory purposes only. In practice, environment 700 may include additional devices and/or networks, fewer devices and/or networks, different devices and/or networks, or differently arranged devices and/or networks than illustrated in FIG. 7. For example, while not shown, environment 700 may include devices that facilitate or enable communication between various components shown in environment 700, such as routers, modems, gateways, switches, hubs, etc. In some implementations, one or more devices of environment 700 may be physically integrated in, and/or may be physically attached to, one or more other devices of environment 700. Alternatively, or additionally, one or more of the devices of environment 700 may perform one or more network functions described as being performed by another one or more of the devices of environment 700.

Additionally, one or more elements of environment 700 may be implemented in a virtualized and/or containerized manner. For example, one or more of the elements of environment 700 may be implemented by one or more Virtualized Network Functions (“VNFs”), Cloud-Native Network Functions (“CNFs”), etc. In such embodiments, environment 700 may include, may implement, and/or may be communicatively coupled to an orchestration platform that provisions hardware resources, installs containers or applications, performs load balancing, and/or otherwise manages the deployment of such elements of environment 700. In some embodiments, such orchestration and/or management of such elements of environment 700 may be performed by, or in conjunction with, the open-source Kubernetes^{®}application programming interface (“API”) or some other suitable virtualization, containerization, and/or orchestration system.

Elements of environment 700 may interconnect with each other and/or other devices via wired connections, wireless connections, or a combination of wired and wireless connections. Examples of interfaces or communication pathways between the elements of environment 700, as shown in FIG. 7, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 7, such as Service-Based Interfaces (“SBIs”), including an Namf interface, an Nudm interface, an Npcf interface, an Nupf interface, an Nnef interface, an Nsmf interface, and/or one or more other SBIs.

UE 701 may include a computation and communication device, such as a wireless mobile communication device that is capable of communicating with RAN 710, RAN 712, and/or DN 750. UE 701 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 701 may send traffic to and/or receive traffic (e.g., user plane traffic) from DN 750 via RAN 710, RAN 712, and/or UPF/PGW-U 735.

RAN 710 may be, or may include, a 5G RAN that implements a 5G RAT and that includes one or more base stations (e.g., one or more gNBs 711), via which UE 701 may communicate with one or more other elements of environment 700. UE 701 may communicate with RAN 710 via an air interface (e.g., as provided by gNB 711). For instance, RAN 710 may receive traffic (e.g., user plane traffic such as voice call traffic, data traffic, messaging traffic, etc.) from UE 701 via the air interface, and may communicate the traffic to UPF/PGW-U 735 and/or one or more other devices or networks. Further, RAN 710 may receive signaling traffic, control plane traffic, etc. from UE 701 via the air interface, and may communicate such signaling traffic, control plane traffic, etc. to AMF 715 and/or one or more other devices or networks. Additionally, RAN 710 may receive traffic intended for UE 701 (e.g., from UPF/PGW-U 735, AMF 715, and/or one or more other devices or networks) and may communicate the traffic to UE 701 via the air interface.

RAN 712 may be, or may include, an LTE RAN that implements an LTE RAT and that includes one or more base stations (e.g., one or more eNBs 713), via which UE 701 may communicate with one or more other elements of environment 700. UE 701 may communicate with RAN 712 via an air interface (e.g., as provided by eNB 713). For instance, RAN 712 may receive traffic (e.g., user plane traffic such as voice call traffic, data traffic, messaging traffic, signaling traffic, etc.) from UE 701 via the air interface, and may communicate the traffic to UPF/PGW-U 735 (e.g., via SGW 717) and/or one or more other devices or networks. Further, RAN 712 may receive signaling traffic, control plane traffic, etc. from UE 701 via the air interface, and may communicate such signaling traffic, control plane traffic, etc. to MME 716 and/or one or more other devices or networks. Additionally, RAN 712 may receive traffic intended for UE 701 (e.g., from UPF/PGW-U 735, MME 716, SGW 717, and/or one or more other devices or networks) and may communicate the traffic to UE 701 via the air interface.

One or more RANs of environment 700 (e.g., RAN 710 and/or RAN 712) may include, may implement, and/or may otherwise be communicatively coupled to one or more edge computing devices, such as one or more Multi-Access/Mobile Edge Computing (“MEC”) devices (referred to sometimes herein simply as a “MECs”) 714. MECs 714 may be co-located with wireless network infrastructure equipment of RANs 710 and/or 712 (e.g., one or more gNBs 711 and/or one or more eNBs 713, respectively). Additionally, or alternatively, MECs 714 may otherwise be associated with geographical regions (e.g., coverage areas) of wireless network infrastructure equipment of RANs 710 and/or 712. In some embodiments, one or more MECs 714 may be implemented by the same set of hardware resources, the same set of devices, etc. that implement wireless network infrastructure equipment of RANs 710 and/or 712. In some embodiments, one or more MECs 714 may be implemented by different hardware resources, a different set of devices, etc. from hardware resources or devices that implement wireless network infrastructure equipment of RANs 710 and/or 712. In some embodiments, MECs 714 may be communicatively coupled to wireless network infrastructure equipment of RANs 710 and/or 712 (e.g., via a high-speed and/or low-latency link such as a physical wired interface, a high-speed and/or low-latency wireless interface, or some other suitable communication pathway).

MECs 714 may include hardware resources (e.g., configurable or provisionable hardware resources) that may be configured to provide services and/or otherwise process traffic to and/or from UE 701, via RAN 710 and/or 712. For example, RAN 710 and/or 712 may route some traffic from UE 701 (e.g., traffic associated with one or more particular services, applications, application types, etc.) to a respective MEC 714 instead of to core network elements of 700 (e.g., UPF/PGW-U 735). MEC 714 may accordingly provide services to UE 701 by processing such traffic, performing one or more computations based on the received traffic, and providing traffic to UE 701 via RAN 710 and/or 712. MEC 714 may include, and/or may implement, some or all of the functionality described above with respect to UPF/PGW-U 735, AF 730, one or more application servers, and/or one or more other devices, systems, VNFs, CNFs, etc. In this manner, ultra-low latency services may be provided to UE 701, as traffic does not need to traverse links (e.g., backhaul links) between RAN 710 and/or 712 and the core network.

AMF 715 may include one or more devices, systems, VNFs, CNFs, etc., that perform operations to register UE 701 with the 5G network, to establish bearer channels associated with a session with UE 701, to hand off UE 701 from the 5G network to another network, to hand off UE 701 from the other network to the 5G network, manage mobility of UE 701 between RANs 710 and/or gNBs 711, and/or to perform other operations. In some embodiments, the 5G network may include multiple AMFs 715, which communicate with each other via the N14 interface (denoted in FIG. 7 by the line marked “N14” originating and terminating at AMF 715).

MME 716 may include one or more devices, systems, VNFs, CNFs, etc., that perform operations to register UE 701 with the EPC, to establish bearer channels associated with a session with UE 701, to hand off UE 701 from the EPC to another network, to hand off UE 701 from another network to the EPC, manage mobility of UE 701 between RANs 712 and/or eNBs 713, and/or to perform other operations.

SGW 717 may include one or more devices, systems, VNFs, CNFs, etc., that aggregate traffic received from one or more eNBs 713 and send the aggregated traffic to an external network or device via UPF/PGW-U 735. Additionally, SGW 717 may aggregate traffic received from one or more UPF/PGW-Us 735 and may send the aggregated traffic to one or more eNBs 713. SGW 717 may operate as an anchor for the user plane during inter-eNB handovers and as an anchor for mobility between different telecommunication networks or RANs (e.g., RANs 710 and 712).

SMF/PGW-C 720 may include one or more devices, systems, VNFs, CNFs, etc., that gather, process, store, and/or provide information in a manner described herein. SMF/PGW-C 720 may, for example, facilitate the establishment of communication sessions on behalf of UE 701. In some embodiments, the establishment of communications sessions may be performed in accordance with one or more policies provided by PCF/PCRF 725.

PCF/PCRF 725 may include one or more devices, systems, VNFs, CNFs, etc., that aggregate information to and from the 5G network and/or other sources. PCF/PCRF 725 may receive information regarding policies and/or subscriptions from one or more sources, such as subscriber databases and/or from one or more users (such as, for example, an administrator associated with PCF/PCRF 725).

AF 730 may include one or more devices, systems, VNFs, CNFs, etc., that receive, store, and/or provide information that may be used in determining parameters (e.g., quality of service parameters, charging parameters, or the like) for certain applications.

UPF/PGW-U 735 may include one or more devices, systems, VNFs, CNFs, etc., that receive, store, and/or provide data (e.g., user plane data). For example, UPF/PGW-U 735 may receive user plane data (e.g., voice call traffic, data traffic, etc.), destined for UE 701, from DN 750, and may forward the user plane data toward UE 701 (e.g., via RAN 710, SMF/PGW-C 720, and/or one or more other devices). In some embodiments, multiple instances of UPF/PGW-U 735 may be deployed (e.g., in different geographical locations), and the delivery of content to UE 701 may be coordinated via the N9 interface (e.g., as denoted in FIG. 7 by the line marked “N9” originating and terminating at UPF/PGW-U 735). Similarly, UPF/PGW-U 735 may receive traffic from UE 701 (e.g., via RAN 710, RAN 712, SMF/PGW-C 720, and/or one or more other devices), and may forward the traffic toward DN 750. In some embodiments, UPF/PGW-U 735 may communicate (e.g., via the N4 interface) with SMF/PGW-C 720, regarding user plane data processed by UPF/PGW-U 735.

UDM/HSS 740 and AUSF 745 may include one or more devices, systems, VNFs, CNFs, etc., that manage, update, and/or store, in one or more memory devices associated with AUSF 745 and/or UDM/HSS 740, profile information associated with a subscriber. In some embodiments, UDM/HSS 740 may include, may implement, may be communicatively coupled to, and/or may otherwise be associated with some other type of repository or database, such as a Unified Data Repository (“UDR”). AUSF 745 and/or UDM/HSS 740 may perform authentication, authorization, and/or accounting operations associated with one or more UEs 701 and/or one or more communication sessions associated with one or more UEs 701.

DN 750 may include one or more wired and/or wireless networks. For example, DN 750 may include an Internet Protocol (“IP”)-based PDN, a wide area network (“WAN”) such as the Internet, a private enterprise network, and/or one or more other networks. UE 701 may communicate, through DN 750, with data servers, other UEs 701, and/or to other servers or applications that are coupled to DN 750. DN 750 may be connected to one or more other networks, such as a public switched telephone network (“PSTN”), a public land mobile network (“PLMN”), and/or another network. DN 750 may be connected to one or more devices, such as content providers, applications, web servers, and/or other devices, with which UE 701 may communicate.

External devices 754 may include one or more devices or systems that communicate with UE 701 via DN 750 and one or more elements of 700 (e.g., via UPF/PGW-U 735). External devices 754 may include, for example, one or more application servers, content provider systems, web servers, or the like. External devices 754 may, for example, implement “server-side” applications that communicate with “client-side” applications executed by UE 701. External devices 754 may provide services to UE 701 such as gaming services, videoconferencing services, messaging services, email services, web services, and/or other types of services. Operations described above with respect to a given external device 754 (e.g., in accordance with some embodiments) may be performed by a single device, by a cloud computing system, by one or more devices that implement a virtualized or containerized environment, a collection of devices, etc.

In some embodiments, external devices 754 may communicate with one or more elements of environment 700 (e.g., core network elements) via NEF/SCEF 749. NEF/SCEF 749 include one or more devices, systems, VNFs, CNFs, etc. that provide access to information, APIs, and/or other operations or mechanisms of one or more core network elements to devices or systems that are external to the core network (e.g., to external device 754 via DN 750). NEF/SCEF 749 may maintain authorization and/or authentication information associated with such external devices or systems, such that NEF/SCEF 749 is able to provide information, that is authorized to be provided, to the external devices or systems. For example, a given external device 754 may request particular information associated with one or more core network elements. NEF/SCEF 749 may authenticate the request and/or otherwise verify that external device 754 is authorized to receive the information, and may request, obtain, or otherwise receive the information from the one or more core network elements. In some embodiments, NEF/SCEF 749 may include, may implement, may be implemented by, may be communicatively coupled to, and/or may otherwise be associated with a Security Edge Protection Proxy (“SEPP”), which may perform some or all of the functions discussed above. External device 754 may, in some situations, subscribe to particular types of requested information provided by the one or more core network elements, and the one or more core network elements may provide (e.g., “push”) the requested information to NEF/SCEF 749 (e.g., in a periodic or otherwise ongoing basis).

In some embodiments, external devices 754 may communicate with one or more elements of RAN 710 and/or 712 via an API or other suitable interface. For example, a given external device 754 may provide instructions, requests, etc. to RAN 710 and/or 712 to provide one or more services via one or more respective MECs 714. In some embodiments, such instructions, requests, etc. may include QoS parameters, Service Level Agreements (“SLAs”), etc. (e.g., maximum latency thresholds, minimum throughput thresholds, etc.) associated with the services.

FIG. 8 illustrates another example environment 800, in which one or more embodiments may be implemented. In some embodiments, environment 800 may correspond to a 5G network, and/or may include elements of a 5G network. In some embodiments, environment 800 may correspond to a 5G SA architecture. In some embodiments, environment 800 may include a 5GC, in which 5GC network elements perform one or more operations described herein.

As shown, environment 800 may include UE 701, RAN 710 (which may include one or more gNBs 711 or other types of wireless network infrastructure) and various network functions, which may be implemented as VNFs, CNFs, etc. Such network functions may include AMF 715, SMF 803, UPF 805, PCF 807, UDM 809, AUSF 745, Network Repository Function (“NRF”) 811, AF 730, UDR 813, and NEF 815. Environment 800 may also include or may be communicatively coupled to one or more networks, such as DN 750.

The example shown in FIG. 8 illustrates one instance of each network component or function (e.g., one instance of SMF 803, UPF 805, PCF 807, UDM 809, AUSF 745, etc.). In practice, environment 800 may include multiple instances of such components or functions. For example, in some embodiments, environment 800 may include multiple “slices” of a core network, where each slice includes a discrete and/or logical set of network functions (e.g., one slice may include a first instance of SMF 803, PCF 807, UPF 805, etc., while another slice may include a second instance of SMF 803, PCF 807, UPF 805, etc.). Additionally, or alternatively, one or more of the network functions of environment 800 may implement multiple network slices. The different slices may provide differentiated levels of service, such as service in accordance with different QoS parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. In some implementations, one or more devices of environment 800 may be physically integrated in, and/or may be physically attached to, one or more other devices of environment 800. Alternatively, or additionally, one or more of the devices of environment 800 may perform one or more network functions described as being performed by another one or more of the devices of environment 800.

Elements of environment 800 may interconnect with each other and/or other devices via wired connections, wireless connections, or a combination of wired and wireless connections. Examples of interfaces or communication pathways between the elements of environment 800, as shown in FIG. 8, may include interfaces shown in FIG. 8 and/or one or more interfaces not explicitly shown in FIG. 8. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 800 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 715), an Nudm interface (e.g., indicating communications to be routed to UDM 809), an Npcf interface, an Nupf interface, an Nnef interface, an Nsmf interface, an Nnrf interface, an Nudr interface, an Naf interface, and/or one or more other SBIs.

UPF 805 may include one or more devices, systems, VNFs, CNFs, etc., that receive, route, process, and/or forward traffic (e.g., user plane traffic). As discussed above, UPF 805 may communicate with UE 701 via one or more communication sessions, such as PDU sessions. Such PDU sessions may be associated with a particular network slice or other suitable QoS parameters, as noted above. UPF 805 may receive downlink user plane traffic (e.g., voice call traffic, data traffic, etc. destined for UE 701) from DN 750, and may forward the downlink user plane traffic toward UE 701 (e.g., via RAN 710). In some embodiments, multiple UPFs 805 may be deployed (e.g., in different geographical locations), and the delivery of content to UE 701 may be coordinated via the N9 interface. Similarly, UPF 805 may receive uplink traffic from UE 701 (e.g., via RAN 710), and may forward the traffic toward DN 750. In some embodiments, UPF 805 may implement, may be implemented by, may be communicatively coupled to, and/or may otherwise be associated with UPF/PGW-U 735. In some embodiments, UPF 805 may communicate (e.g., via the N4 interface) with SMF 803, regarding user plane data processed by UPF 805 (e.g., to provide analytics or reporting information, to receive policy and/or authorization information, etc.).

PCF 807 may include one or more devices, systems, VNFs, CNFs, etc., that aggregate, derive, generate, etc. policy information associated with the 5GC and/or UEs 701 that communicate via the 5GC and/or RAN 710. PCF 807 may receive information regarding policies and/or subscriptions from one or more sources, such as subscriber databases (e.g., UDM 809, UDR 813, etc.), and/or from one or more users such as, for example, an administrator associated with PCF 807. In some embodiments, the functionality of PCF 807 may be split into multiple network functions or subsystems, such as AM PCF 817, SM PCF 819, UE PCF 821, and so on. Such different “split” PCFs may be associated with respective SBIs (e.g., AM PCF 817 may be associated with an Nampcf SBI, SM PCF 819 may be associated with an Nsmpcf SBI, UE PCF 821 may be associated with an Nuepcf SBI, BSF 103 may be associated with an Nbsf SBI, and so on) via which other network functions may communicate with the split PCFs. The split PCFs may maintain information regarding policies associated with different devices, systems, and/or network functions.

NRF 811 may include one or more devices, systems, VNFs, CNFs, etc. that maintain routing and/or network topology information associated with the 5GC. For example, NRF 811 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 813 may include one or more devices, systems, VNFs, CNFs, etc. that provide user and/or subscriber information, based on which PCF 807 and/or other elements of environment 800 may determine access policies, QoS policies, charging policies, or the like. In some embodiments, UDR 813 may receive such information from UDM 809 and/or one or more other sources.

NEF 815 include one or more devices, systems, VNFs, CNFs, etc. that provide access to information, APIs, and/or other operations or mechanisms of the 5GC to devices or systems that are external to the 5GC. NEF 815 may maintain authorization and/or authentication information associated with such external devices or systems, such that NEF 815 is able to provide information, that is authorized to be provided, to the external devices or systems. Such information may be received from other network functions of the 5GC (e.g., as authorized by an administrator or other suitable entity associated with the 5GC), such as SMF 803, UPF 805, a charging function (“CHF”) of the 5GC, and/or other suitable network function. NEF 815 may communicate with external devices or systems (e.g., external devices 754) via DN 750 and/or other suitable communication pathways.

While environment 800 is described in the context of a 5GC, as noted above, environment 800 may, in some embodiments, include or implement one or more other types of core networks. For example, in some embodiments, environment 800 may be or may include a converged packet core, in which one or more elements may perform some or all of the functionality of one or more 5GC network functions and/or one or more EPC network functions. For example, in some embodiments, AMF 715 may include, may implement, may be implemented by, and/or may otherwise be associated with MME 716; SMF 803 may include, may implement, may be implemented by, and/or may otherwise be associated with SGW 717; PCF 807 may include, may implement, may be implemented by, and/or may otherwise be associated with a PCRF (e.g., PCF/PCRF 725); NEF 815 may include, may implement, may be implemented by, and/or may otherwise be associated with a SCEF (e.g., NEF/SCEF 749); and so on.

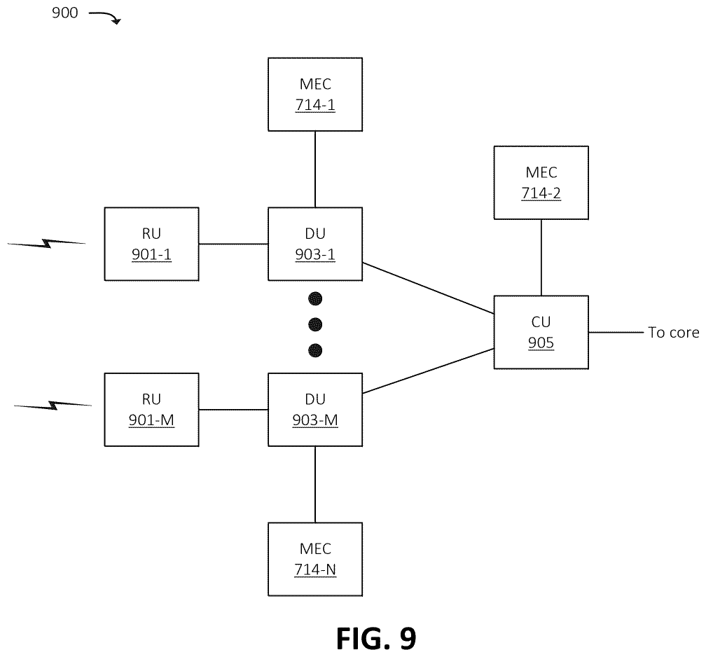

FIG. 9 illustrates an example RAN environment 900, which may be included in and/or implemented by one or more RANs (e.g., RAN 710 or some other RAN). In some embodiments, a particular RAN 710 may include one RAN environment 900. In some embodiments, a particular RAN 710 may include multiple RAN environments 900. In some embodiments, RAN environment 900 may correspond to a particular gNB 711 of RAN 710. In some embodiments, RAN environment 900 may correspond to multiple gNBs 711. In some embodiments, RAN environment 900 may correspond to one or more other types of base stations of one or more other types of RANs. As shown, RAN environment 900 may include Central Unit (“CU”) 905, one or more Distributed Units (“DUs”) 903-1 through 903-M (referred to individually as “DU 903,” or collectively as “DUs 903”), and one or more Radio Units (“RUs”) 901-1 through 901-M (referred to individually as “RU 901,” or collectively as “RUs 901”).

CU 905 may communicate with a core of a wireless network (e.g., may communicate with one or more of the devices or systems described above with respect to FIG. 8, such as AMF 715 and/or UPF 805) and/or some other device or system such as MEC 714. In the uplink direction (e.g., for traffic from UEs 701 to a core network), CU 905 may aggregate traffic from DUs 903, and forward the aggregated traffic to the core network. In some embodiments, CU 905 may receive traffic according to a given protocol (e.g., Radio Link Control (“RLC”) traffic) from DUs 903, and may perform higher-layer processing (e.g., may aggregate/process RLC packets and generate Packet Data Convergence Protocol (“PDCP”) packets based on the RLC packets) on the traffic received from DUs 903.

CU 905 may receive downlink traffic (e.g., traffic from the core network, traffic from a given MEC 714, etc.) for a particular UE 701, and may determine which DU(s) 903 should receive the downlink traffic. DU 903 may include one or more devices that transmit traffic between a core network (e.g., via CU 905) and UE 701 (e.g., via a respective RU 901). DU 903 may, for example, receive traffic from RU 901 at a first layer (e.g., physical (“PHY”) layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 701.

RU 901 may include hardware circuitry (e.g., one or more RF transceivers, antennas, radios, and/or other suitable hardware) to communicate wirelessly (e.g., via an RF interface) with one or more UEs 701, one or more other DUs 903 (e.g., via RUs 901 associated with DUs 903), and/or any other suitable type of device. In the uplink direction, RU 901 may receive traffic from UE 701 and/or another DU 903 via the RF interface and may provide the traffic to DU 903. In the downlink direction, RU 901 may receive traffic from DU 903, and may provide the traffic to UE 701 and/or another DU 903.

One or more elements of RAN environment 900 may, in some embodiments, be communicatively coupled to one or more MECs 714. For example, DU 903-1 may be communicatively coupled to MEC 714-1, DU 903-M may be communicatively coupled to MEC 714-N, CU 905 may be communicatively coupled to MEC 714-2, and so on. MECs 714 may include hardware resources (e.g., configurable or provisionable hardware resources) that may be configured to provide services and/or otherwise process traffic to and/or from UE 701, via a respective RU 901.

For example, DU 903-1 may route some traffic, from UE 701, to MEC 714-1 instead of to a core network via CU 905. MEC 714-1 may process the traffic, perform one or more computations based on the received traffic, and may provide traffic to UE 701 via RU 901-1. As discussed above, MEC 714 may include, and/or may implement, some or all of the functionality described above with respect to UPF 805, AF 730, and/or one or more other devices, systems, VNFs, CNFs, etc. In this manner, ultra-low latency services may be provided to UE 701, as traffic does not need to traverse DU 903, CU 905, links between DU 903 and CU 905, and an intervening backhaul network between RAN environment 900 and the core network.

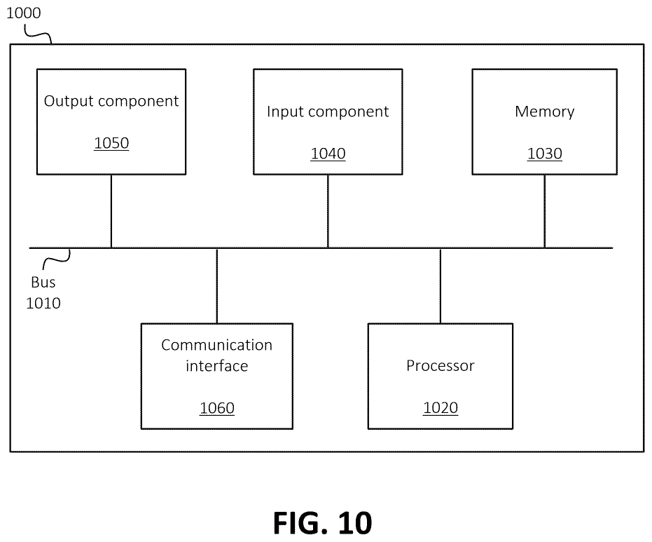

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to input component 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems (e.g., via RAN 710, RAN 712, DN 750, etc.). For example, communication interface 1060 may include an Ethernet interface, an optical interface, a coaxial interface, or the like. Communication interface 1060 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1000 may include more than one communication interface 1060. For instance, device 1000 may include an optical interface, a wireless interface, an Ethernet interface, and/or one or more other interfaces.

Device 1000 may perform certain operations relating to one or more processes described above. Device 1000 may perform these operations in response to processor 1020 executing instructions, such as software instructions, processor-executable instructions, etc. stored in a computer-readable medium, such as memory 1030. A computer-readable medium may be defined as a non-transitory memory device. A memory device may include space within a single physical memory device or spread across multiple physical memory devices. The instructions may be read into memory 1030 from another computer-readable medium or from another device. The instructions stored in memory 1030 may be processor-executable instructions that cause processor 1020 to perform processes described herein. Alternatively, hardwired circuitry may be used in place of or in combination with software instructions to implement processes described herein. Thus, implementations described herein are not limited to any specific combination of hardware circuitry and software.

A first example embodiment includes a device, comprising one or more processors configured to: maintain binding information that associates respective PCFs of a wireless network with respective UEs that are connected to the wireless network; receive a subscription request, from a particular NF of the wireless network, for binding information updates associated with a particular UE; initiate, based on receiving the subscription request, a subscription timer that is associated with the particular NF; receive, prior to expiration of the subscription timer, one or more binding information updates associated with the particular UE; notify, based on the subscription request, the particular NF of the one or more binding information updates received prior to expiration of the subscription timer; determine that the subscription timer has expired; and forgo notifying the particular NF of binding information updates received after expiration of the subscription timer.

In a second example embodiment, the device of the first example embodiment includes a BSF of a wireless network.

A third example embodiment includes the device of the first example embodiment, wherein one or more binding information updates associated with the particular UE specify a particular PCF that maintains policy information associated with the particular UE.

A fourth example embodiment includes the device of the third example embodiment, wherein the one or more binding updates associated with the particular UE specify a particular SM PCF that maintains SM policy information associated with the particular UE.

A fifth example includes the device of the fourth example embodiment, wherein receiving the subscription request from the particular NF includes receiving the subscription request from an AM PCF of the wireless network, and wherein notifying the particular NF of the one or more binding information updates includes notifying the AM PCF of the one or more binding information updates.

A sixth example embodiment includes the device of the first example embodiment, wherein the subscription request specifies a particular duration, and wherein initiating the subscription timer includes initiating the subscription timer based on the particular duration.

A seventh example embodiment includes the device of the first example embodiment, wherein the subscription request specifies a first duration, wherein the one or more processors are further configured to: determine a second duration that is different from the first duration, and wherein initiating the subscription timer includes initiating the subscription timer based on the second duration.

Some example embodiments include a non-transitory computer-readable medium, storing plurality of processor-executable instructions to perform one or more operations described above with respect to the first through the seventh embodiments, and/or other embodiments described above. Some example embodiments include a method that includes performing one or more of the operations described above with respect to the first through the seventh embodiments, and/or other embodiments described above.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks, operations, and/or signals have been described above (e.g. with regard to FIGS. 1-6), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set. Concepts described above may be embodied by, for example, a device, devices, a system, systems, a method, methods, a non-transitory computer-readable medium, and/or non-transitory computer-readable media, as provided for in the claims.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
maintain binding information that associates respective Policy Control Function (“PCFs”) of a wireless network with respective User Equipment (“UEs”) that are connected to the wireless network;
receive a subscription request, from a particular Network Function (“NF”) of the wireless network, for binding information updates associated with a particular UE;
initiate, based on receiving the subscription request, a subscription timer that is associated with the particular NF;
receive, prior to expiration of the subscription timer, one or more binding information updates associated with the particular UE;
notify, based on the subscription request, the particular NF of the one or more binding information updates received prior to expiration of the subscription timer;
determine that the subscription timer has expired; and
forgo notifying the particular NF of binding information updates received after expiration of the subscription timer.

2. The device of claim 1, wherein the device includes a Binding Support Function (“BSF”) of a wireless network.

3. The device of claim 1, wherein the one or more binding information updates associated with the particular UE specify a particular Policy Control Function (“PCF”) that maintains policy information associated with the particular UE.

4. The device of claim 3, wherein the one or more binding updates associated with the particular UE specify a particular Session Management (“SM”) PCF that maintains SM policy information associated with the particular UE.

5. The device of claim 4, wherein receiving the subscription request from the particular NF includes receiving the subscription request from an Access and Mobility (“AM”) PCF of the wireless network, and wherein notifying the particular NF of the one or more binding information updates includes notifying the AM PCF of the one or more binding information updates.

6. The device of claim 1, wherein the subscription request specifies a particular duration, and wherein initiating the subscription timer includes initiating the subscription timer based on the particular duration.

7. The device of claim 1, wherein the subscription request specifies a first duration, wherein the one or more processors are further configured to:
determine a second duration that is different from the first duration, and
wherein initiating the subscription timer includes initiating the subscription timer based on the second duration.

8. A non-transitory computer-readable medium, storing a plurality of processor-executable instructions to:
maintain binding information that associates respective Policy Control Function (“PCFs”) of a wireless network with respective User Equipment (“UEs”) that are connected to the wireless network;
receive a subscription request, from a particular Network Function (“NF”) of the wireless network, for binding information updates associated with a particular UE;
initiate, based on receiving the subscription request, a subscription timer that is associated with the particular NF;
receive, prior to expiration of the subscription timer, one or more binding information updates associated with the particular UE;
notify, based on the subscription request, the particular NF of the one or more binding information updates received prior to expiration of the subscription timer;
determine that the subscription timer has expired; and
forgo notifying the particular NF of binding information updates received after expiration of the subscription timer.

9. The non-transitory computer-readable medium of claim 8, wherein maintaining the binding information and notifying the particular NF of the one or more binding information updates are performed by a Binding Support Function (“BSF”) of a wireless network.

10. The non-transitory computer-readable medium of claim 8, wherein the one or more binding information updates associated with the particular UE specify a particular Policy Control Function (“PCF”) that maintains policy information associated with the particular UE.

11. The non-transitory computer-readable medium of claim 10, wherein the one or more binding updates associated with the particular UE specify a particular Session Management (“SM”) PCF that maintains SM policy information associated with the particular UE.

12. The non-transitory computer-readable medium of claim 11, wherein receiving the subscription request from the particular NF includes receiving the subscription request from an Access and Mobility (“AM”) PCF of the wireless network, and wherein notifying the particular NF of the one or more binding information updates includes notifying the AM PCF of the one or more binding information updates.

13. The non-transitory computer-readable medium of claim 8, wherein the subscription request specifies a particular duration, and wherein initiating the subscription timer includes initiating the subscription timer based on the particular duration.

14. The non-transitory computer-readable medium of claim 8, wherein the subscription request specifies a first duration, wherein the plurality of processor-executable instructions further include processor-executable instructions to:
determine a second duration that is different from the first duration, and
wherein initiating the subscription timer includes initiating the subscription timer based on the second duration.

15. A method, comprising:
maintaining binding information that associates respective Policy Control Function (“PCFs”) of a wireless network with respective User Equipment (“UEs”) that are connected to the wireless network;
receiving a subscription request, from a particular Network Function (“NF”) of the wireless network, for binding information updates associated with a particular UE;
initiating, based on receiving the subscription request, a subscription timer that is associated with the particular NF;
receiving, prior to expiration of the subscription timer, one or more binding information updates associated with the particular UE;
notifying, based on the subscription request, the particular NF of the one or more binding information updates received prior to expiration of the subscription timer;
determining that the subscription timer has expired; and
forgoing notifying the particular NF of binding information updates received after expiration of the subscription timer.

16. The method of claim 15, wherein maintaining the binding information and notifying the particular NF of the one or more binding information updates are performed by a Binding Support Function (“BSF”) of a wireless network.

17. The method of claim 15, wherein the one or more binding updates associated with the particular UE specify a particular Session Management Policy Control Function (“SM PCF”) that maintains SM policy information associated with the particular UE.

18. The method of claim 17, wherein receiving the subscription request from the particular NF includes receiving the subscription request from an Access and Mobility (“AM”) PCF of the wireless network, and wherein notifying the particular NF of the one or more binding information updates includes notifying the AM PCF of the one or more binding information updates.

19. The method of claim 15, wherein the subscription request specifies a particular duration, and wherein initiating the subscription timer includes initiating the subscription timer based on the particular duration.

20. The method of claim 15, wherein the subscription request specifies a first duration, the method further comprising:
determining a second duration that is different from the first duration, and
wherein initiating the subscription timer includes initiating the subscription timer based on the second duration.
